(19) United States
(12) Patent Application Publication
(10) Pub. No.: US 2016/0155077 A1
(43) Pub. Date: Jun. 2, 2016

(54) GENERATING A GREEN BUSINESS GUIDE

(71) Applicant: Opower, Inc., Arlington, VA (US)

(72) Inventor: Wayne Lin, Washington, DC (US)

(21) Appl. No.: 14/558,534

(22) Filed: Dec. 2, 2014

(51) Int. Cl. G06Q 10/06; G06F 17/30

(52) U.S. Cl. CPC G06Q 10/06393; G06F 17/30864; G06F 17/30554

(57) ABSTRACT

Techniques for determining efficiency ratings for businesses are disclosed. A computing device can identify energy efficient entities (e.g., homes, buildings, businesses, points of interest, etc.) for a geographic region. The efficiency of an entity can be determined based on that entity's consumption of resources including, for example, electricity, water, natural gas, etc., that are delivered to a dwelling or commercial structure of the entity, for example. Entities can be scored and ranked based on their respective energy efficiencies. Such entity efficiency information can be presented to users, for example, in the form of a listing of entities (e.g., “green business guide”) that provides various information describing those entities, together with respective efficiency ratings for each of the businesses. Users can reference the listing, for example, when deciding which businesses to support in an effort to promote businesses that value energy conservation.

### BACKGROUND

Entities (e.g., individuals or businesses) typically do not have knowledge of how much energy has been consumed and/or how large a utility bill is expected until they receive a utility bill. Similarly, entities that are interested in learning about the energy usage of another that entity is typically limited to relying on third-party certifications (e.g., “Energy Star”). In many cases, such information about businesses is limited as it simply indicates whether a given business meets a certain usage threshold.

### BRIEF DESCRIPTION OF THE DRAWINGS

In the following description, reference is made to the following figures, and in which are shown by way of illustration specific embodiments in which the subject technology may be practiced. Other embodiments may be utilized and changes may be made without departing from the scope of the subject technology.

FIG. 1 illustrates an example interface that provides a listing of energy efficient entities in accordance with various embodiments;

FIG. 2 illustrates an example alert notification in accordance with various embodiments;

FIG. 3 illustrates an example interface for obtaining efficiency information for various entities in accordance with various embodiments;

FIG. 4 illustrates an example process for obtaining efficiency information for entities;

FIG. 5 illustrates an example process for generating efficiency information for entities;

FIG. 6 illustrates an example of an environment for implementing aspects in accordance with various embodiments;

FIG. 7 illustrates another example of an environment for implementing aspects in accordance with various embodiments; and

FIG. 8 illustrates an example configuration of components of a computing device.

### DETAILED DESCRIPTION

Various embodiments of the disclosure are discussed in detail below. While specific implementations are discussed, it should be understood that this is done for purposes of illustration. A person skilled in the relevant art will recognize that other components and configurations may be used without parting from the spirit and scope of the disclosure.

Systems and methods in accordance with various embodiments of the present disclosure overcome one or more of the above-referenced and other deficiencies in conventional approaches to identifying energy efficient entities (e.g., homes, buildings, businesses, points of interest, etc.). In particular, various embodiments of the present disclosure can be utilized to determine respective energy efficiencies of entities. The efficiency of an entity can be determined based on that entity's consumption of resources including, for example, electricity, water, natural gas, etc., that are delivered to a dwelling or commercial structure of the entity, for example.

In various embodiments, energy consumption of electric use may be measured using the kilowatt hour (kWh or kilowatt*hour), which is a unit of energy equal to 1,000 watt-hours. For example, if the energy is being transmitted or used at a constant rate (power) over a period of time, the total energy in kilowatt-hours is based on the product of the power in kilowatts and the time in hours. The kilowatt hour is just one example of how energy usage can be measured and, naturally, other approaches for measuring energy or resource consumption can be used in accordance with various embodiments. Entities can be scored and ranked based on their respective energy efficiencies. Such entity efficiency information can be presented to users, for example, in the form of a listing of entities (e.g., “green business guide”) that provides various information describing those entities, together with respective efficiency ratings for each of the businesses. Users can reference the listing, for example, when deciding which businesses to support.

Various approaches described herein can be implemented using a server or computing device having at least one processor and memory for storing instructions that, when executed by the processor, cause the server or computing device to perform operations. As used herein, the term “usage” can refer to a quantity of use, a cost associated with the use, or a quantified metric representing the use or cost. The term “energy usage” or “commodity usage” described herein can refer to a meter reading or a usage reading. The term “property” described herein can include components of the property that are able to consume a commodity. One example of a component of a property may be a heating, ventilation and air conditioning (HVAC) system that controls the climate within the property using electricity, natural gas, and/or another commodity. The component may relate to one or more of a central heating device, a central air conditioning and heating system, an appliance, an electronic device, water heating system, a power generating device, a ventilation system, or an air filtration system.

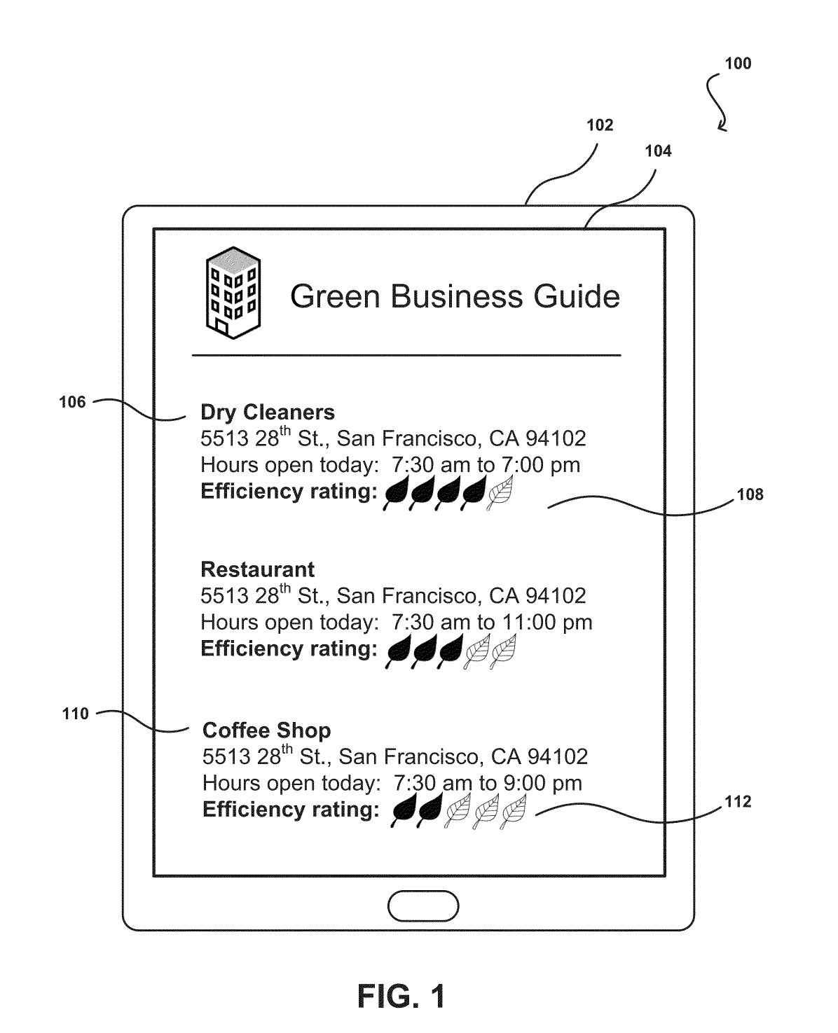

FIG. 1 illustrates an example 100 that provides a listing 104 of energy efficient entities in accordance with various embodiments. The listing 104 may be displayed on a display screen of a computing device 102, for example, through a software application (e.g., web browser or executable application) that is running on the computing device 102.

In various embodiments, the listing 104 can be provided to a user in the form of a communication (e.g., e-mail or message), for example, at periodical intervals (e.g., weekly, monthly, etc.) and can include various entities (e.g., businesses) that are located near the user. Further, the user can also access the listing 104, for example, by browsing through a website or other application that is configured to provide access to such listings. Depending on the implementation, the user's location may be a location identified in the a user profile (e.g., home address, work address, mailing address, service address, etc.) or the location may be determined using other geolocation techniques, for example, based on geolocation information provided by the computing device 102.

The listing 104 can include various information describing those entities including, for example, a location or address for each entity, a distance from a location associated with the user (e.g., the geolocation information provided by the computing device 102) to the location of the entity, respective hours of operation, and a corresponding efficiency rating for the entity, as determined using the approaches described herein. The efficiency ratings can provide the user with information that shows how efficient such entities are in relation to one another. For example, the entity “Dry Cleaners” 106 is determined to have an efficiency rating of “4,” as visually illustrated by the four leaves shaded leaves 108. In contrast, the entity “Coffee Shop” 110 is determined to have an efficiency rating of “2,” as visually illustrated by the two shaded leaves 112. The efficiency rating can be determined by evaluating respective consumptions of a commodity (e.g., electricity, water, natural gas, etc.) or combination of such commodities by the entities in the listing 104. In various embodiments, entities in the listing 104 can be ranked based on their respective efficiency ratings.

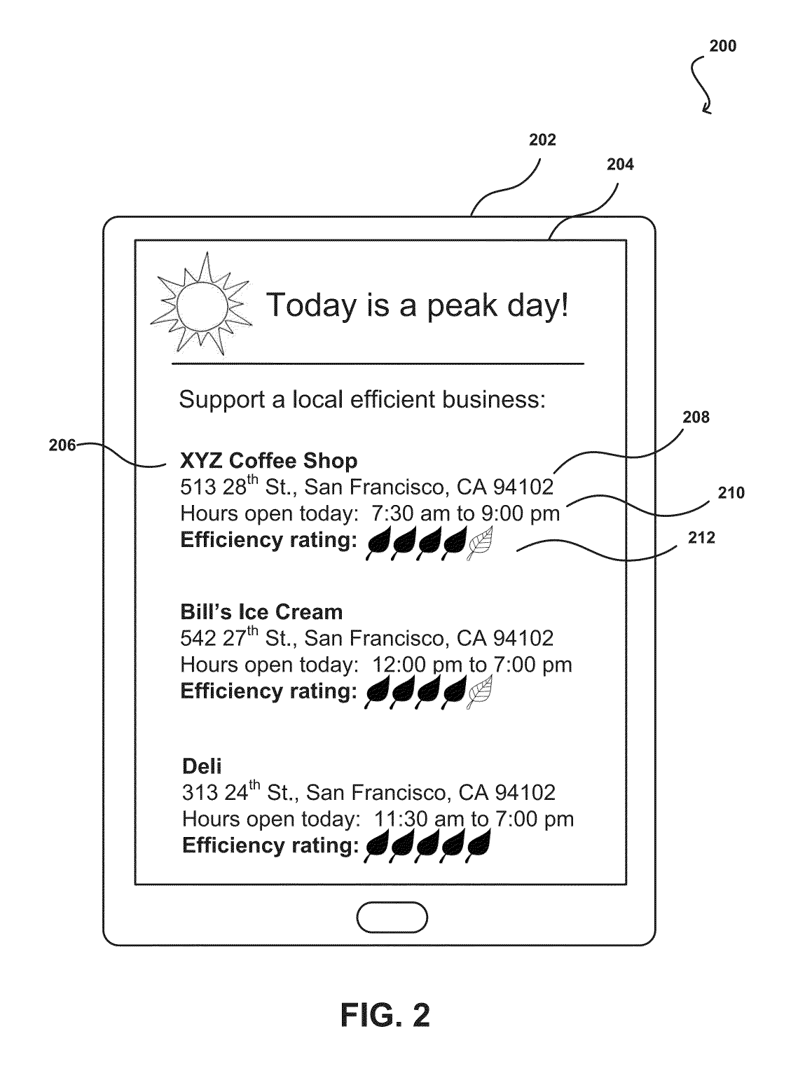

FIG. 2 illustrates an example 200 that provides an alert notification 204 in accordance with various embodiments. The alert 204 may be displayed on a display screen of a computing device 202, for example, through a software application (e.g., web browser or executable application) that is running on the computing device 202.

In various embodiments, the alert 204 can be provided to a user in the form of a communication (e.g., push notification, message, or e-mail), for example, in response to one or more triggering events. For example, the alert 204 can be sent on a day during which there is determined to be high demand for some commodity, such as electricity (e.g., “peak day”). Another example triggering event may result from an outage at a utility company from which the demand for energy is not going to be satisfied. The alert 204 can include information that provides a listing of entities near a user. Thus, for example, the user has the option of powering down any appliances in the user's home and visiting one of the entities in the listing to help reduce some of the user's energy consumption.

Additional triggering events may include triggering events set and/or triggered by the system determining that a set of conditions has been satisfied, by a third party (e.g., a utility can signal a peak day, an issue with energy production and/or distribution, or a potential shortage of energy), or by another entity (e.g., a governmental entity may issue a “spare the air” day). Triggering events may also be set and/or triggered by a user. For example, a user may request a list of nearby energy efficient businesses, the user may indicate a preference to receive the alert 204 when the temperature exceeds or drops below a certain temperature, or the user may indicate a preference to receive the alert 204 when the energy rates or costs exceed a certain threshold.

As shown in FIG. 2, the alert 204 can include information describing various entities (e.g., businesses) that are located near the user. Such information can include, for example, a name of the entity 206, a location or address 208 for the entity, respective hours of operation of the entity 210, and a corresponding efficiency rating 212 for the entity, as determined using the approaches described herein.

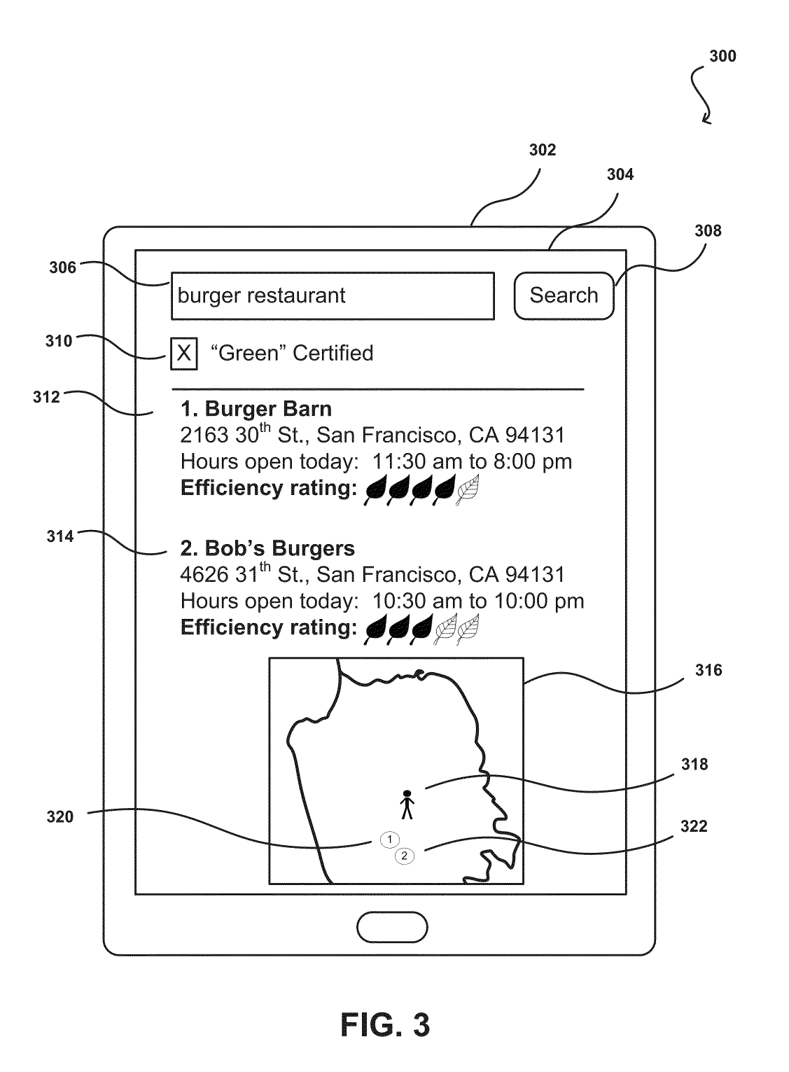

FIG. 3 illustrates an example 300 for obtaining efficiency information for various entities in accordance with various embodiments. In this example, a search interface 304 may be presented through a display screen of a computing device 302, for example, through a software application (e.g., web browser or executable application) that is running on the computing device 302.

The search interface 304 can include a search field 306 in which a user can input terms (e.g., “burger restaurant”) to search for various entities (e.g., businesses or other points of interest) and can submit the search query by selecting a search button 308. In various embodiments, the interface 304 can provide various options for filtering entities that match the user's search query. For example, entities can be filtered by a distance from the user, user ratings or reviews, hours of operation, and/or efficiency rating. In some embodiments, entities that satisfy certain efficiency criteria can be endorsed (e.g., “Green” certified or efficiency rating that exceeds a threshold). In such embodiments, the user can also filter entities based on whether or not such entities are endorsed 310.

Information describing entities that satisfy the user's search criteria can be obtained and presented on the computing device 302 in response to the user's search query. In the example of FIG. 3, in response to the user's search query “burger restaurant,” the interface 304 is presenting information on entities “Burger Barn” 312 and “Bob's Burgers” 314 that match the query. As mentioned, for each entity, the interface 304 can provide information including, for example, a name of the entity, a location or address for the entity, respective hours of operation of the entity, a corresponding efficiency rating for the entity, etc. In some embodiments, the interface 304 also provides a geographic map 316 that identifies the geographic location of the user 318 along with the respective geographic locations 320 and 322 of the entities 312 and 314.

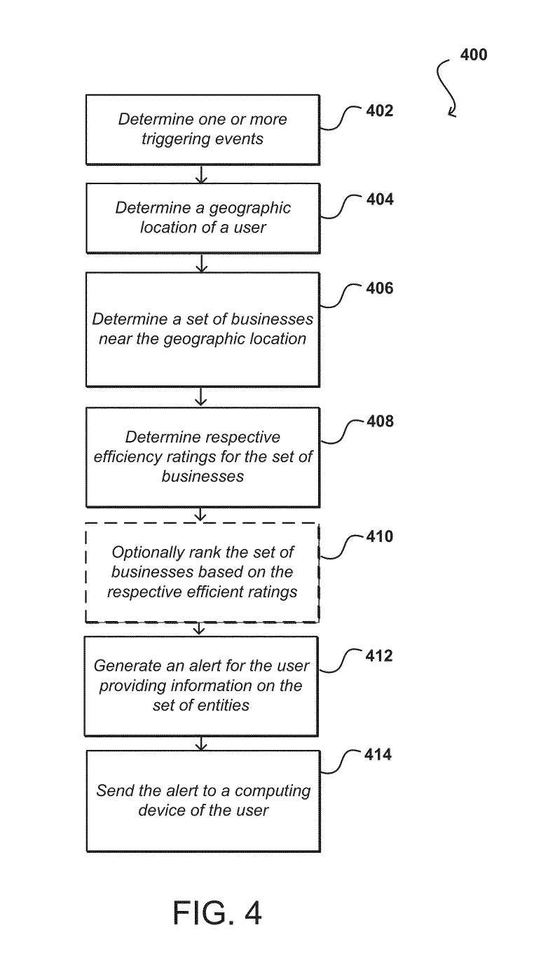

FIG. 4 illustrates a flowchart of an example process 400 for sending energy usage alerts, according to certain aspects of the subject technology. The example process 400 is provided merely as an example and additional or fewer steps may be performed in similar or alternative orders, or in parallel, within the scope of the various embodiments described in this specification.

A computing device can determine occurrence of any triggering events 402 for sending energy usage alerts to users. The triggering events or conditions for the triggering events may be a triggering event identified by the computing device and/or a triggering event set by another entity separate from the computing device or received from another entity via a network. Such triggering events may include, for example, determining that peak time period (e.g., peak hours, day, week, month, etc.) for a geographic region. For example, the peak time period may be determined based on an analysis of consumption by a given entity or group of entities for a given commodity over a period of time (e.g., a number of days, months, year, season, etc.). The analysis can also be based on other types of data including historical weather data for various periods of time (e.g., days, months, years, seasons, etc.) in various geographic regions or locations and also forecasted weather data for various periods of times for various geographic regions or locations. For example, the analysis may indicate a high demand for electricity during a particular day or season (e.g., summer). The triggering events may correspond to a particular geographic region. For example, one city may have, or be expected to have, a higher electricity demand or more difficulty meeting electricity demands than another region.

The computing device can determine a geographic location of a user 404 to which the alert is to be provided. The user location may be specified in a user profile or may be determined using various geolocation techniques. The computing device can also determine 406 a set of businesses that are located in, or near, the geographic location of the user. The computing device can make such a determination by evaluating the respective addresses of businesses and determining whether they in, or within a threshold proximity, of the user's location. The computing device can also determine 408 respective efficiency ratings for businesses in the set of businesses, as described herein.

Alternatively, in some implementations, the set of businesses is determined based on the respective efficiency ratings of businesses in the set. For example, when determining the set of businesses, the computing device can determine a listing of any businesses that are located in, or near, the geographic location of the user, together with the respective efficiency ratings for the businesses. The computing device can rank the businesses in the listing based on their respective efficiency ratings. Once ranked, the computing device can select a portion (e.g., a specified number or percentage) of the businesses in the listing to be included in the set based on the respective efficiency ratings for those businesses. For example, the computing device can select the top 10 ranked businesses in the listing to be included in the set. In another example, the computing device can determine which businesses in the listing are ranked in the top 10 percent of all businesses in the listing and select the businesses in the top 10 percent to be included in the set.

The computing device can optionally rank 410 businesses in the set based on the respective efficiency ratings. For example, businesses can be ranked in an ascending order in which the businesses are ranked from the lowest efficiency rating to the highest efficiency rating. The computing device can generate 412 an alert for the user. As mentioned, the alert can include various information describing businesses in the set of businesses including, for example, business names, addresses, hours of operations, and respective efficiency ratings for each business. The computing device can send 414 the alert to a computing device of the user for presentation. Determining which computing device to send the alert may be based on information provided by the user in a user profile, for example. That is, the alert may be sent to an e-mail address of the user, a notification on a software application running on the device, an electronic message (e.g., text message or SMS message), etc.

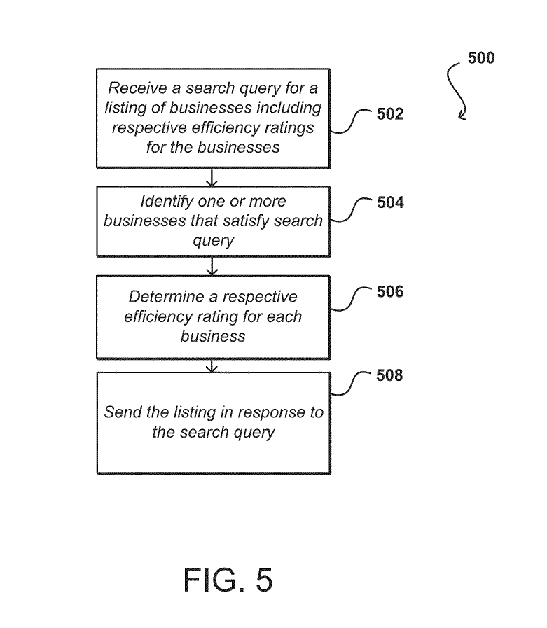

FIG. 5 illustrates a flowchart of an example process 500 for providing efficiency information in response to search queries, according to certain aspects of the subject technology. The example process 500 is provided merely as an example and additional or fewer steps may be performed in similar or alternative orders, or in parallel, within the scope of the various embodiments described in this specification.

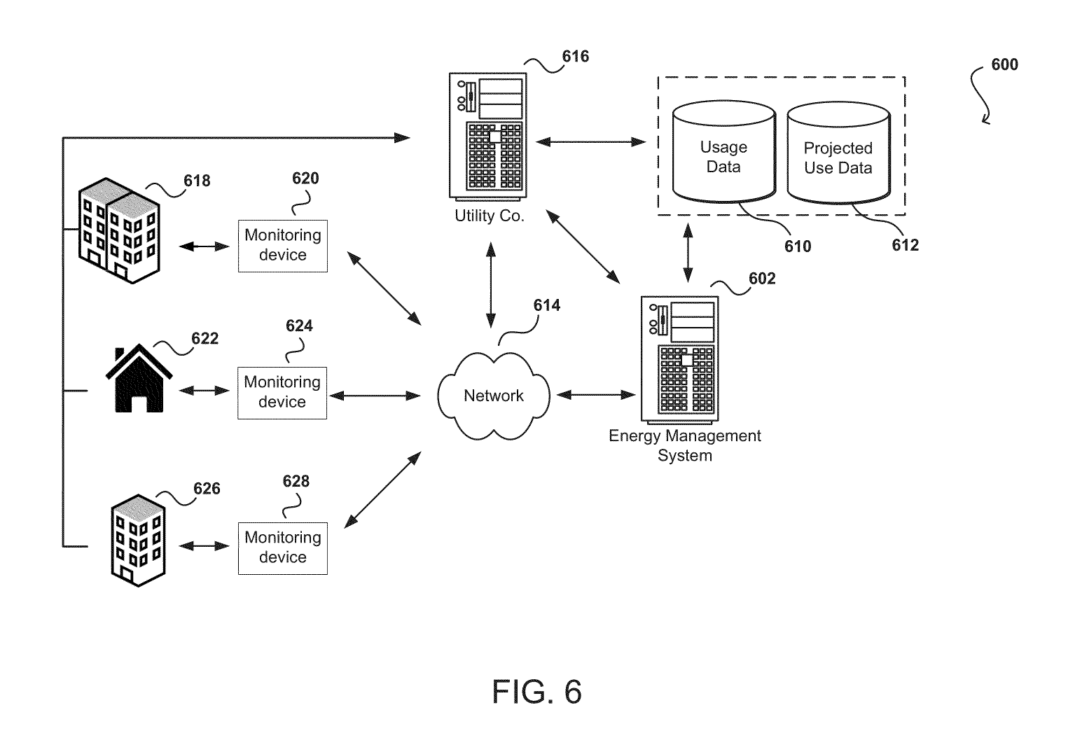

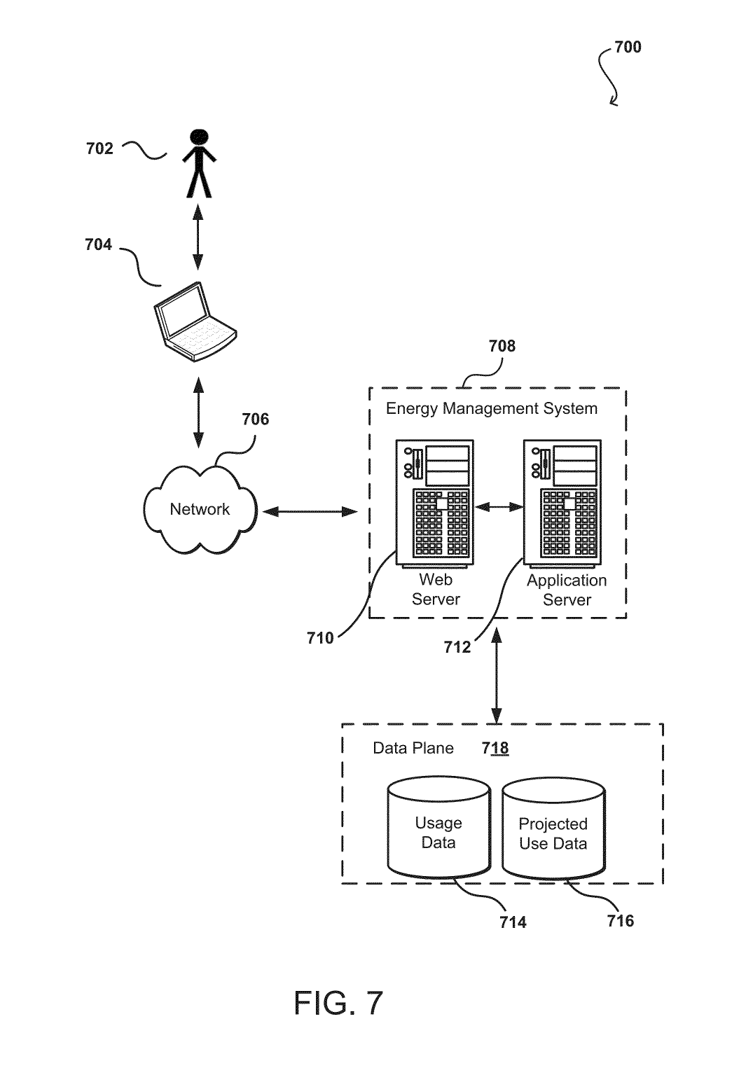

A computing system can receive 502 a search query from a client device. The search query may request information describing a particular point of interest (e.g., by referencing a business name) or a set of points of interest (e.g., a listing) that satisfy various search criteria (e.g., businesses located within a geographic region, businesses of a particular type or category, businesses that are open for business, businesses having a certain efficiency rating, and/or green endorsement). The system can identify 504 one or more points of interest that satisfy the query. For example, the system can identify points of interest by matching terms in the search query and information describing the points of interest. For example, a particular business may be responsive to the query based on a match between the search terms and the business name, address, hours of operation, distance from the user operating the client device, etc. The system can determine 506 respective efficiency ratings for the set of points of interest that are responsive to the search query, as described in reference to FIGS. 6 and 7. The system can send 508, to the client device, a listing of the set of points of interest together with various information describing those points of interest in the set including, for example, respective point of business names, addresses, hours of operations, efficiency ratings, and/or endorsements, to name some examples.

FIG. 6 illustrates an example environment 600 of an energy management system 602 in accordance with various embodiments. The energy management system 602 is able to interact with data stores that store usage data 610 and projected use data 612. The usage data 610 may include information describing entity usage of various commodities (e.g., electricity, water, natural gas, etc.). Such usage information may include data describing respective amounts used (e.g., “usage”) of various commodities by a given entity over a period of time (e.g., one or more billing periods, over a period of hours, days, years, a current usage of the commodity during a completed portion of a current billing period or cycle, etc.) The usage data 610 and/or the projected use data 612 may be maintained by the energy management system 602 or such data may be accessed by the energy management system 602 by interacting with the utility management system 616. The utility management system 616 may be maintained by a utility company or a third-party service provider that interfaces with the utility company.

The utility management system 616 can access or interact with various monitoring devices 620, 624, and 628 to obtain commodity usage data corresponding to various entities 618, 622, and 626. Each of the monitoring devices 620, 624, 628 can monitor the usage for a corresponding entity 618, 622, and 626. An entity can refer to any physical structure or property to which the commodity is provided. Thus, an entity may refer to, for example, a home, a building, business, point of interest (e.g., a library or museum), etc. Each monitoring device can measure, collect, and/or analyze the commodity usage of an entity with which the device is associated. For example, the monitoring device 620 can be configured to measure, collect, and/or analyze the energy usage of the entity 618. A monitoring device can be any computing device that is configured to collect and/or measure the usage of a given commodity. Some examples of monitoring devices include smart meters, electricity meters, gas meters, heat meters, and water meters. The entity management system 602 can communicate with each of the monitoring devices 620, 624, and 628, to obtain usage data for the respective entities 618, 622, and 626. Such communication may be performed on an as needed basis, periodically, or based on a defined schedule. In various embodiments, the energy management system 602 may utilize an advanced metering infrastructure (AMI) to facilitate the measuring, collection, and/or analysis of usage data.

The utility management system 616 may track the energy usage from geographic regions using the monitoring devices associated with each entity in the corresponding region. The utility management system 616 may receive usage data that includes the amount of energy consumption (e.g., kWH) for the corresponding utility account. In some embodiments, the utility management system 616 receives the usage data through a wireless communication system. In some embodiments, the utility management system 616 may obtain the usage data by pulling the usage data from each of the monitoring devices. The monitoring devices may broadcast usage data on a periodic or scheduled basis. The utility management system 616 also may receive the usage data from each monitoring device through a wired communication system.

The utility management system 616 and/or the energy management system 602 can also determine and store data describing the projected commodity usage for entities. This projected use may be based on an analysis of consumption by a given entity or group of entities for a given commodity over a period of time (e.g., a number of days, months, year, season, etc.), for example, as determined using the usage data 610. The projected use can also be based on other types of data including historical weather data for various periods of time (e.g., days, months, years, seasons, etc.) in various geographic regions or locations and also forecasted weather data for various periods of times for various geographic regions or locations. For example, the projected use may indicate a high demand for electricity during the summer for a region resulting from customer or entity demand for air conditioning. Such information can also be used to determine whether there is expected to be high demand for a commodity during a specified time period (e.g., “peak days”) and/or for a particular geographic region. In some instances, this projection can be refined based on an amount of time remaining in the current billing period for the entity. For example, the utility management system 616 and/or the energy management system 602 may obtain the usage data 610 to determine a rate of use for a utility customer. The rate of use may be based on the amount of energy consumed over a specified number of days, for example. This rate may then be applied to the amount of time remaining in the billing cycle for the entity to determine the estimated usage for the billing cycle.

In various embodiments, the energy management system 602 can be configured to evaluate the usage data 610 and the projected use data 612 to determine efficiency ratings or scores for various entities (e.g., businesses or other points of interest). In some embodiments, the energy management system 602 can generate an efficiency rating corresponding to an entity based on a consumption of a commodity by an entity over a period of time as compared to the respective consumption of the same commodity by other entities over the period of time. The period of time may be defined as a specified number of days, months, years, seasons, or some other time period.

When comparing the consumption of a first entity against other entities, such a comparison may be done by comparing the consumption of the first entity against each entity in the other entities. Such an approach allows the first entity to be ranked with respect to the other entities based on their respective consumptions. In some embodiments, each entity can further be assigned an efficiency percentile that ranks the entity in relation to other entities. One example formula for determining an efficiency percentile rank for an entity is:

$$R = \frac{P}{100} * ( N + 1 ) \qquad ( Equation 1 )$$

where R represents the rank of the entity in comparison to the other entities based on consumption, P represents the percentile rank, N represents the number of entities being compared.

In some embodiments the energy management system 602 can obtain a set of entities that are similar to the first entity. A first entity and a second entity may be determined to be similar based on evaluating various factors or characteristics of the entities. Such factors or characteristics of an entity may be obtained from a utility account profile for the entity, for example. Depending on the implementation, one or a combination of these factors may be used to determine whether entities or businesses are similar. For example, one factor to determine whether two entities are similar is a location category for the entities (e.g., urban location, suburban location, rural location, etc.). Another factor to determine whether two entities are similar is the type or category of the points of interest or businesses (e.g., pizzeria, donut shop, bar, restaurant, grocery store, library, museum, etc.). Another factor to determine whether two entities are similar is the size of the entity (e.g., number of employees, square footage, etc.).

When determining the set of similar entities to be used to evaluate the first entity, the energy management system 602 may restrict the set to entities that are similar and that are also located within a particular geographic region (e.g., neighborhood, district, city, state, geofence, etc.) corresponding to the first entity or within a particular proximity (e.g., radius) from the first entity.

In another approach, the energy management system 602 may determine an average consumption by a set of entities that are similar to the first entity and then compare the consumption of the first entity with the average consumption. In this example, the first entity may receive a poor energy efficiency rating if the first entity uses 20 percent more energy than the average amount of energy used by the other entities in the set. Alternatively, the first entity may receive a high efficiency rating if the first entity uses 15 percent less energy that the average amount of energy used by the other entities in the set.

Naturally, other approaches for comparing consumption are possible. In another example, the first entity's consumption may be compared with respect to a certain percentage of entities in the set. For example, the first entity may receive a poor energy efficiency rating if the first entity uses more energy than 90 percent of the other entities in the set. In another example, the first entity may receive a high efficiency rating if the first entity uses less energy that 80 percent of the other entities in the set.

The terms “poor” and “high” are used simply to provide an example of how an efficiency rating for a given entity may be measured. In some implementations, entities can simply be labeled as having a low efficiency rating or a high efficiency rating. In some implementations, the efficiency ratings may be determined by ranking entities in the set based on their respective efficiency percentile ranks, as described above. Once ranked, entities can be assigned ratings based on threshold efficiency percentile ranks. For example, entities having an efficiency percentile rank between 0 and 20 percent can be assigned a score of “1,” entities having an efficiency percentile rank between 20 and 40 percent can be assigned a score of “2,” entities having an efficiency percentile rank between 40 and 60 percent can be assigned a score of “3,” entities having an efficiency percentile rank between 60 and 80 percent can be assigned a score of “4,” and entities having an efficiency percentile rank between 80 and 100 percent can be assigned a score of “5.” Such scores can be translated into a visual representation using, for example, a number of icons (e.g., leaves or stars) that indicate the overall efficiency rating of the entity with respect to other entities. These thresholds are provided as examples and, naturally, other thresholds or ranges can be defined.

In some embodiments, entities that satisfy a threshold efficiency rating (e.g., satisfying a threshold score or percentile) can be endorsed, for example, as a “green business.” Such an endorsement can be used by third-party content providers to identify the entities are being energy efficient. In various embodiments, such an endorsement can be used by users as an option to filter entities in a listing of entities to be provided in response to a query.

FIG. 7 illustrates another example of an environment 700 for implementing aspects in accordance with various embodiments. Although a web-based environment is described for purposes of explanation, different environments may be used, as appropriate, to implement various embodiments.

The example of FIG. 7 illustrates a user 702 utilizing a computing device 704 interacting with an energy management system 708. The energy management system 708 includes at least one web server 710 and at least one application server 712, as described below. The energy management system 708 can be implemented on one or more computers in one or more locations using one or more computer programs, in which the systems, components, and techniques described throughout this specification can be implemented.

The energy management system 708 and the various approaches described herein provide various technical solutions to technical problems that exist in known technologies. For example, unlike existing technologies, the energy management system 708 and the various approaches described herein provide the ability to obtain and integrate data from various sources (e.g., utility data, business information, event triggers, etc.), for example, to determine energy efficient businesses for any given geographic region, and to provide such information through an interface, e.g., a graphical user interface.

A user can interact with the energy management system 708 through a client device 704. For example, the client device 704 can be a computer coupled to the energy management system 708 through a network 706 (e.g., the Internet). The energy management system 708 can be implemented on the client device 704, for example, through a software application executing on the client device 704. The client device 704 generally includes memory (e.g., random access memory), for storing instructions and data, and a processor for executing stored instructions. The client device 704 can be any appropriate device operable to send and receive requests, messages, or other types of information over the data communication network 706. The client device 704 can also include a display screen though which the user interacting with the client device 704 can view information. Some examples of client devices include personal computers, smart thermostats, cellular phones, handheld messaging devices, laptop computers, mobile devices, smart appliances, set-top boxes, personal data assistants, electronic book readers, tablet devices, smartphones and the like.

The network 706 can include any appropriate network, including an intranet, the Internet, a cellular network, a local area network, a wide area network, or any other such network, or combination thereof. Protocols and components for communicating over such a network are well known and will not be discussed herein in detail. The client device 704 can communicate over the network 706 using wired or wireless connections, and combinations thereof.

A user 702 can access the client device 704 to interact with the energy management system 708 over a network 706, for example, to obtain information describing various entities and their respective efficiencies. For example, the client device 704 can send a search request or query to the energy management system, for example, through the web server 710, to obtain information describing a particular entity (e.g., “Sam's Coffee Shop”) and its respective efficiency rating. The energy management system 708 can determine an efficiency rating (e.g., “5-star rating”) for the particular entity, for example, by processing the usage data 714 and the projected use data 716 using the application server 712, as described above with reference to FIG. 6. The rating can be represented differently depending on the implementation. For example, the rating may be represented on a scale of some predefined number (e.g., a scale of “1” to “5,” with “5” being the most efficient and “1” being least efficient). Naturally, the scale can be represented in various ways, for example, by displaying a number of icons of some type (e.g., leaves or stars) with the higher number of icons signifying more efficiency.

The energy management system 708 can send the requested data describing the particular entity to the client device 704 over the network 706. This data may include various information describing the entity including, for example, a business name, geographic location or address, user reviews of the entity, distance from the user, times or hours of operations, and one or more respective efficiency ratings (or scores) for the entity. As mentioned, the efficiency rating may be determined based on evaluating a consumption of a commodity (e.g., electricity) by the entity over a given period of time. In some embodiments, the efficiency rating may be determined based on evaluating a consumption of a combination of commodities (e.g., electricity, water, natural gas, etc.) by the entity over a given period of time.

In some instances, the user 702 accessing the client device 704 may simply want information describing a listing of entities located within a geographic region. The geographic region may be specified by the user 702, determined based on geolocating the client device 704, or determined based on a location (e.g., a home address or work address) stored in a user profile or account. In such instances, the client device 704 can send the query or request for the listing to the energy management system 708 over the network 706. The energy management system 708 can determine a listing of one or more entities that are located within or near (e.g., based on a geographic radius) the requested or geolocated geographic region. The energy management system 708 can also rank the entities in the listing. For example, the energy management system 708 can rank entities based on the respective efficiency ratings or scores for each entity (e.g., in descending order in which entities are ranked from the highest efficiency rating to the lowest efficiency rating or in ascending order in which entities are ranked from the lowest efficiency rating to the highest efficiency rating), the respective distance of the entity from the user 702, business type or category, search terms used in the user's request or query, respective popularity scores for the entities, user ratings or reviews, or a combination thereof, to name some examples. When ranking, some information to perform the ranking may be obtained from third-party content providers. For example, popularity scores may be determined based on the number of check-ins or user visits to the entity, the number of user ratings and/or reviews. The energy management system 708 can send data describing this ranked listing to the client device 704 over the network 706. In some embodiments, the energy management system 708 can send data describing this ranked listing to users via other communications channels as well, such as via direct hard copy mailings of the ranked listing. For example, the ranked listing may come through the mail as a standalone communication or be a part of a user's utility bill.

Upon receiving the data describing a particular entity or a listing of entities, a software application, e.g., web browser or application, running on the client device 704 can present the information describing entities and their respective efficiency ratings, as illustrated in FIG. 1. As mentioned, the information presented can also include other types of information describing the entities including, for example, a business name, category (e.g., bars, restaurants, fast food, etc.), geographic address, hours of operation, together with other user reviews and/or ratings. In some embodiments, the information can also include a geographic map of the region in which the entities are located. The map can be annotated to indicate the locations of the requested entity or entities in the listing of entities, together with an indication of the user's location.

In some embodiments, the user 702 need not submit a query to the energy management system 708 to obtain the listing of entities. In such embodiments, the energy management system 708 can automatically provide the client device 704 with information about an entity or a listing of entities in response to various events. For example, on occasions which the energy management system 708 determines or receives an indication (e.g., from a utility) that there is to be high demand for a commodity (e.g., electricity), the energy management system 708 can generate an alert that describes the triggering event (e.g., “peak day”) and provides alternatives for ways users can help reduce the consumption of that commodity to alleviate some of the demand, as described in reference to FIG. 2. The energy management system 708 can determine such triggering events (e.g., high demand for a given day or time period) by evaluating usage data 714 and projected use information 716, as described above. Upon receiving data describing the alert, the software application, e.g., web browser or application, running on the client device 704 can present the alert information to the user 702, for example, as a message, email, or notification. In various embodiments, information (e.g., alert information) may be provided to the user 702 via an e-mail, message, or some in other electronic form. The energy management system 708 can generate and send such communications, for example, through an e-mail server or some other communication network or medium. In some instances, such information may be physically mailed to the user in a printed document that includes the information.

The web server 710 and the application server 712, and similar components, can be configured to handle requests and responses. Further, the delivery of content between the client device 704 and the application server 712 can be facilitated by the web server 710. The web server 710 and the application server 712 are merely example components. However, more or fewer components can be used as structured code can be executed on any appropriate device or host machine as discussed elsewhere herein.

The data plane 718 can include one or more resources, servers, hosts, instances, routers, switches, data stores, other similar components, or a combination thereof. The resources of the data plane 718 are not limited to storing and providing access to data. Indeed, there may be several servers, layers, or other elements, processes, or components, which may be chained or otherwise configured, and which can interact to perform tasks including, for example, obtaining data from an appropriate data store. In some embodiments, the term “data store” refers to any device or combination of devices capable of storing, accessing, and retrieving data, which may include any combination and number of data servers, databases, data storage devices, and data storage media, in any standard, distributed, or clustered environment.

The data stores (e.g., usage data 714 and projected use data 716) of the data plane 718 can include several separate data tables, databases, or other data storage mechanisms and media for storing data relating to a particular aspect. For example, the data plane 718 illustrated includes mechanisms for storing usage data 714 and other information 716, which can be used to perform the various operations described throughout this specification. The data plane 718 is operable, through logic associated therewith, to receive instructions from the application server 712 and to obtain, update, or otherwise process data, instructions, or other such information in response thereto, as described above.

Each server typically includes an operating system that provides executable program instructions for the general administration and operation of that server, and typically will include a computer-readable medium storing instructions that, when executed by a processor of the server, enable the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment including several computer systems and components that are interconnected through one or more communication links, using one or more computer networks or direct connections. However, the system described above can be configured to operate equally well using fewer or a greater number of components than are illustrated in FIG. 7. Thus, the system 700 in FIG. 7 is provided merely as one example, and does not limit the scope of the disclosure.

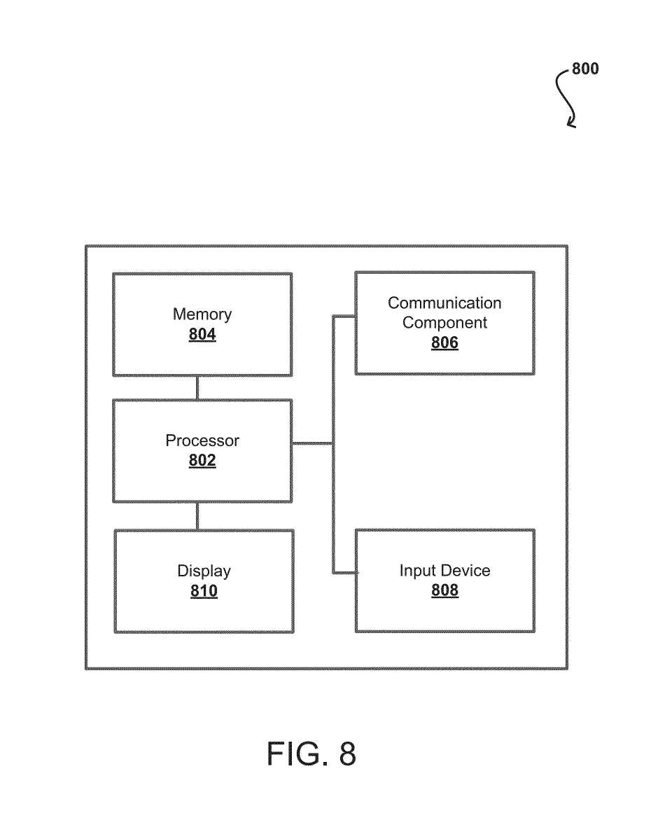

FIG. 8 illustrates an example configuration of components of a computing device 800, e.g., the computing device 704 of FIG. 7, according to certain aspects of the subject technology. In this example, the computing device 800 includes a processor 802 for executing instructions that can be stored in a memory device or element 804. The instructions may cause the computing device 800 to execute computer-implemented methods and/or receive instructions. As would be apparent to one of ordinary skill in the art, the computing device 800 can include many types of memory, data storage, or non-transitory computer-readable storage media, such as a first data storage for program instructions for execution by the processor 802, a separate storage for usage history or user information, a removable memory for sharing information with other devices, etc. In some embodiments, the computing device 800 can include one or more communication components 806, such as a Wi-Fi, Bluetooth®, radio frequency, near-field communication, wired, or wireless communication system. The computing device 800 in many embodiments can communicate with a network, such as the Internet, and may be able to communicate with other such devices (e.g., the energy usage alert system 100, other climate control devices). As discussed, the computing device 800 in many embodiments will include at least one input element 808 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. The computing device 800 includes some type of display element 810, such as a touch screen or liquid crystal display (LCD).

The various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business map servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these embodiments will be readily apparent to those skilled in the art, and generic principles defined herein may be applied to other embodiments. Thus, many changes and modifications may be made to the subject technology, by one having ordinary skill in the art, without departing from the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A computing device, the computing device comprising:
at least one processor; and
memory storing instructions that, when executed by the at least one processor, cause the computing device to perform the operations of:
receiving, from a client device, a search query for businesses that are located in a geographic region;
identifying a first business and a second business, both the first business and the second business being located in the geographic region;
determining a first energy efficiency score for the first business, the first energy efficiency score being based in part on an overall energy consumption by the first business over a period of time;
determining a second energy efficiency score for the second business, the second energy efficiency score being based in part on an overall energy consumption by the second business over the period of time; and
providing, to the client device, a listing of businesses that are located in the geographic region, the listing including information describing the first business and the second business, wherein the information also includes the first efficiency score for the first business and the second efficiency score for the second business.

2. The computing device of claim 1, wherein the instructions further cause the computing device to perform the operations of:
determining that the second business is more energy efficient than the first business based on the first energy efficiency score and the second energy efficiency score; and
generating the listing in which an ordering of the second business is higher than an ordering of the first business.

3. The computing device of claim 1, wherein the instructions further cause the computing device to perform the operations of:
determining that the first business is similar to the second business, wherein the similarity is based on a comparison of at least one of: a respective location category for the first business and the second business, a respective business type or category for the first business and the second business, a respective number of employees employed by the first business and the second business, or a respective property size of the first business and the second business.

4. A computer-implemented method, comprising:
identifying a plurality of entities that are located in, or within a threshold distance of, a geographic region associated with a user;
determining a respective efficiency rating for each entity in the plurality of entities, the efficiency rating being based at least in part on an overall consumption of a commodity by the entity over a period of time; and
sending, to the user, a listing of entities that includes information describing the plurality of entities, the listing including the respective efficiency ratings for each of the plurality of entities.

5. The computer-implemented method of claim 4, further comprising:
determining an ordering for the plurality of entities in the listing based at least in part on the respective efficiency ratings for each of the plurality of entities.

6. The computer-implemented method of claim 4, further comprising:
receiving, from a client device, a request for information describing entities that are located in a geographic region.

7. The computer-implemented method of claim 4, wherein sending the listing to the user comprises initiating at least one of emailing the listing to an email address associated with the user, transmitting the listing to a client device associated with the user, or mailing the listing to an mailing address associated with the user.

8. The computer-implemented method of claim 4, wherein determining the respective efficiency rating for each entity in the plurality of entities further comprises:
determining an average consumption of the commodity by entities in the plurality of entities; and
determining the respective efficiency rating for each entity in the plurality of entities based at least in part on a comparison of a respective consumption of the commodity by the entity and the average consumption of the commodity.

9. The computer-implemented method of claim 4, wherein determining the respective efficiency rating for each entity in the plurality of entities further comprises:
determining a first set of entities in the plurality of entities that are similar; and
determining the respective efficiency rating for each entity in the first set based at least in part on a respective consumption of the commodity by the entity relative to other entities in the first set.

10. The computer-implemented method of claim 9, wherein determining the first set of entities in the plurality of entities that are similar further comprises:
determining that one or more features associated with a first entity match one or more features associated with a second entity, wherein the features include at least one of: a location category, a business type or category, a size of a structure that consumed at least some of the commodity, or a number of employees.

11. The computer-implemented method of claim 4, wherein the commodity is one of: electricity, water, natural gas, or other consumable source of energy.

12. The computer-implemented method of claim 4, wherein determining the respective efficiency rating for each entity in the plurality of entities further comprises:
determining the respective efficiency rating for each entity in the plurality of entities based at least in part on a respective consumption of the commodity by the entity relative to other entities in the plurality of entities.

13. The computer-implemented method of claim 4, further comprising:
receiving, from the client device, a second request for information describing a particular entity;
determining an efficiency rating for the particular entity based at least in part on an overall consumption of the commodity by the particular entity over the period of time; and
sending, to the client device, information describing the particular entity, the information including the efficiency rating for the particular entity.

14. A computer-implemented method, comprising:
determining at least one event for a geographic region, the event being triggered based at least in part on an overall consumption of a commodity by at least one entity;
determining one or more entities that are located in the geographic region and that each satisfy a threshold level of efficiency, the threshold level of efficiency being based at least in part on a respective consumption of the commodity by the one or more entities; and
providing a listing of the one or more entities to at least one customer.

15. The computer-implemented method of claim 14, wherein the listing further includes, for each entity in the one or more entities, information describing a respective efficiency rating for the entity.

16. The computer-implemented method of claim 15, wherein the efficiency rating for an entity measures a consumption of the commodity by the entity relative to the respective consumption of the commodity by other entities in the one or more entities.

17. The computer-implemented method of claim 15, wherein the efficiency rating is represented as at least one of: a percentile, a numerical value corresponding to a predefined scale, or a number of icons that visually represent the efficiency rating.

18. The computer-implemented method of claim 14, wherein providing the listing further comprises:
sending, to a computing device of the at least one user, a push notification describing the at least one event and the listing of the one or more entities, or
sending a message describing the at least one event and the listing of the one or more entities to an account of the user.

19. The computer-implemented method of claim 14, wherein determining the at least one event for a geographic region further comprises:
determining that the overall consumption of the commodity by the entities located in the geographic region exceeds a threshold amount, or
determining a forecast indicating that the overall consumption of the commodity is expected to exceed the threshold amount.

20. A system, the system comprising:
at least one processor; and
memory storing instructions that, when executed by the at least one processor, cause the computing device to perform the operations of:
means for identifying a plurality of entities that are located in, or within a threshold distance of, a geographic region associated with a user;
means for determining a respective efficiency rating for each entity in the plurality of entities, the efficiency rating being based at least in part on an overall consumption of a commodity by the entity over a period of time; and
means for sending, to the user, a listing of entities that includes information describing the plurality of entities, the listing including the respective efficiency ratings for each of the plurality of entities.
